(19) United States
(12) Patent Application Publication
(10) Pub. No.: US 2019/0306556 A1
(43) Pub. Date: Oct. 3, 2019

(54) INTELLIGENT RECOGNITION-PAIRING FOR REMOTE MEDIA PLAYBACK SYSTEMS

(71) Applicant: DISH Network L.L.C., Englewood, CO (US)

(72) Inventor: Sanjiv Topiwalla, Parker, CO (US)

(21) Appl. No.: 15/942,210

(22) Filed: Mar. 30, 2018

(51) Int. Cl. H04N 21/414; H04W 48/16; H04W 8/00; H04N 21/436

(52) U.S. Cl. CPC H04N 21/41407; H04W 48/16; H04N 21/43637; H04N 21/43615; H04W 8/005

(57) ABSTRACT

Novel techniques are described for recognizing subscriber devices that have not downloaded and properly configured a specialized application for remote coordination between the subscriber device and the subscriber's set-top box. For example, a network discovery routine can be executed by a set-top box communicatively coupled with a local area network (LAN) router, thereby discovering a portable device communicatively coupled with the LAN router. A pairing data store can be queried by the set-top box to determine that the discovered portable device is a presently unpaired portable device with respect to the remote media playback system. A prompt can be communicated to the presently unpaired portable device automatically in response to the querying, the prompt directing the presently unpaired portable device to pair with the remote media playback system.

### FIELD

This invention relates generally to video playback systems, and, more particularly, to intelligent recognition-pairing for remote media playback systems.

### BACKGROUND

Television users have become accustomed to increased flexibility when watching television. For example, subscribers to television programming, such as satellite television programming, often have access to hundreds of channels, advanced program guides, on-demand programming, digital video recording and storage, and other features that provide viewing flexibility. However, the subscribers tend to be limited in where they can access their subscription programming and other related services. For example, such programming and features are typically provided through specialized equipment, like set-top boxes, and viewing of programming can be restricted to the location of the set-top box (e.g., to a television plugged into the set-top box) or availability of internet or other wireless service.

### BRIEF SUMMARY

Among other things, embodiments provide novel systems and methods for recognizing subscriber devices that have not downloaded and properly configured a specialized application for remote coordination between the subscriber device and the subscriber's set-top box. For example, a network discovery routine can be executed by a set-top box communicatively coupled with a local area network (LAN) router, thereby discovering a portable device communicatively coupled with the LAN router. A pairing data store can be queried by the set-top box to determine that the discovered portable device is a presently unpaired portable device with respect to the remote media playback system. A prompt can be communicated to the presently unpaired portable device automatically in response to the querying, the prompt directing the presently unpaired portable device to pair with the remote media playback system.

According to one set of embodiments, a television receiver is provided, including one or more processors and a memory. The memory is communicatively coupled with, and readable by, the one or more processors and has stored therein processor-readable instructions which, when executed by the one or more processors, cause the one or more processors to: communicatively couple with a local-area network (LAN); execute a network discovery routine to discover whether a portable device is communicatively coupled with the LAN; query a pairing data store, in response to the network discovery routine discovering that the portable device is communicatively coupled with the local-area network, to determine whether the discovered portable device is a presently unpaired portable device with respect to a remote media playback system associated with the television receiver; and communicate a prompt to the presently unpaired portable device, automatically in response to the query determining that the discovered portable device is a presently unpaired portable device, the prompt directing the presently unpaired portable device to pair with the remote media playback system.

According to another set of embodiments, a method is provided for driving recognition-pairing of a portable device with a remote media playback system. The method includes: executing a network discovery routine by a set-top box communicatively coupled with a LAN router, the executing comprising discovering a portable device communicatively coupled with the LAN router; querying a pairing data store by the set-top box to determine that the discovered portable device is a presently unpaired portable device with respect to the remote media playback system; and communicating a prompt to the presently unpaired portable device automatically in response to the querying, the prompt directing the presently unpaired portable device to pair with the remote media playback system. In some such embodiments, the method also includes receiving a pairing indication in response to the presently unpaired portable device completing a pairing interaction with the remote media playback system; and updating the pairing data store to indicate the presently unpaired portable device as a paired portable device. Some such methods also include detecting that the discovered portable device is a subscriber portable media playback device, wherein the querying is performed in response to the detecting.

According to another set of embodiments, a non-transitory processor-readable medium is provided, including processor-readable instructions that cause one or more processors of a television receiver to: execute a network discovery routine to discover whether a portable device is communicatively coupled with the LAN; query a pairing data store, in response to the network discovery routine discovering that the portable device is communicatively coupled with the local-area network, to determine whether the discovered portable device is a presently unpaired portable device with respect to a remote media playback system associated with the television receiver; and communicate a prompt to the presently unpaired portable device, automatically in response to the query determining that the discovered portable device is a presently unpaired portable device, the prompt directing the presently unpaired portable device to pair with the remote media playback system.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

The present disclosure is described in conjunction with the appended figures:

FIG. 1 shows an illustrative satellite television distribution system as context for various embodiments described herein;

FIG. 2 shows an illustrative television receiver, according to various embodiments. Television receiver may be configured to enable intelligent recognition-pairing techniques described herein;

FIG. 3 shows an illustrative implementation of an intelligent recognition-pairing (IRP) engine, according to various embodiments;

FIG. 4 shows an illustrative remote media playback environment that facilitates remote playback by a paired portable device of subscription and/or other media, according to various embodiments;

FIG. 5 provides a schematic illustration of one embodiment of a computer system that can perform various steps of the methods provided by various embodiments; and

FIG. 6 shows a flow diagram of an illustrative method for driving recognition-pairing of a portable device with a remote media playback system.

In the appended figures, similar components and/or features may have the same reference label. Further, various components of the same type may be distinguished by following the reference label by a second label (e.g., a lower-case letter) that distinguishes among the similar components. If only the first reference label is used in the specification, the description is applicable to any one of the similar components having the same first reference label irrespective of the second reference label.

### DETAILED DESCRIPTION

Many subscribers to television programming, such as satellite television programming, desire to be able to access their content for playback from anywhere. It is common that such service providers deliver subscription television content through set-top boxes, or other specialized devices. For example, a set-top box typically provides an interface between a television content delivery network (e.g., a satellite or cable network) and customer premises equipment (CPE), such as a television; and the set-top box performs various deliver-related functions, such as receiving and filtering many content streams, decoding the content streams into playable content, generating electronic program guides, providing access to stored and on-demand programming, etc. Conventionally, subscribers of such services tended only to be able to access the content using CPE coupled directly to the set-top box, effectively constraining their content access to the location of the set-top box.

One approach to reducing, or even eliminating, constraints on the locations from where subscribers can access their content is to provide a pure over-the-top (OTT) television service, such as a service only accessible by streaming television programming over the Internet. Some such OTT services can be accessed from any location with Internet access via any Internet-enabled device having sufficient playback capability. However, many OTT services provide access only to freely accessible (i.e., non-subscription) content, and/or require users to subscribe separately to the OTT service before being able to access content. For users who want access to particular channels or content, and/or for users who already pay for a different subscription service, such pure OTT services can be undesirable.

A variant of the OTT approach is to provide a dedicated appliance that is part of, or coupled with, a subscriber's set-top box and the Internet. The dedicated appliance can be used to provide subscribers with remote access to many of their set-top box features (e.g., including their real-time linear television programming content, locally cached content, etc.), thereby effectively providing an OTT service through the set-top box. For example, a subscriber who is paying a service provider for certain channels can receive those channels at a set-top box associated with the subscription, and the set-top box can prepare the received channels for playback (e.g., by decoding, descrambling, formatting, etc.). When the subscriber is in a location remote from the set-top box, the subscriber can access the set-top box content by using a remote playback device (e.g., a mobile device, or any other suitable Internet-enabled device that is local to the subscriber and not plugged into the set-top box) to effectively login to the set-top box over the Internet via the dedicated appliance, thereby remotely accessing the prepared content for playback.

Some appliance-based OTT television services rely on coordination between a the dedicated appliance and a specially configured application running on the remote playback device. For example, such coordination can help restrict remote set-top box access only to those subscribers associated with those set-top boxes, and can help provide those subscribers with unfettered access to some or all of their subscription content via their set-top boxes. Subscribers may be unable to exploit the features of such appliance-based OTT television services without first downloading and properly configuring the application for remote coordination between a particular playback device (e.g., a mobile phone) and their set-top boxes. As such, when a subscriber ultimately is in a location that is remote from the set-top box, the subscriber may not know about the appliance-based OTT service, may not know about the remote access application, and/or may not be in an environment conducive to downloading and/or configuring the application.

Embodiments described herein include novel techniques for recognizing subscriber devices that have not downloaded and properly configured a specialized application for remote coordination between the subscriber device and the subscriber's set-top box. For example, a network discovery routine can be executed by a set-top box communicatively coupled with a LAN router, thereby discovering a portable device communicatively coupled with the LAN router. A pairing data store can be queried by the set-top box to determine that the discovered portable device is a presently unpaired portable device with respect to the remote media playback system. A prompt can be communicated to the presently unpaired portable device automatically in response to the querying, the prompt directing the presently unpaired portable device to pair with the remote media playback system.

Embodiments of the disclosed technology will become clearer when reviewed in connection with the description of the figures herein below. In the following description, numerous specific details are set forth to provide a thorough understanding of the present invention. However, one having ordinary skill in the art should recognize that the invention may be practiced without these specific details. In some instances, circuits, structures, and techniques have not been shown in detail to avoid obscuring the present invention.

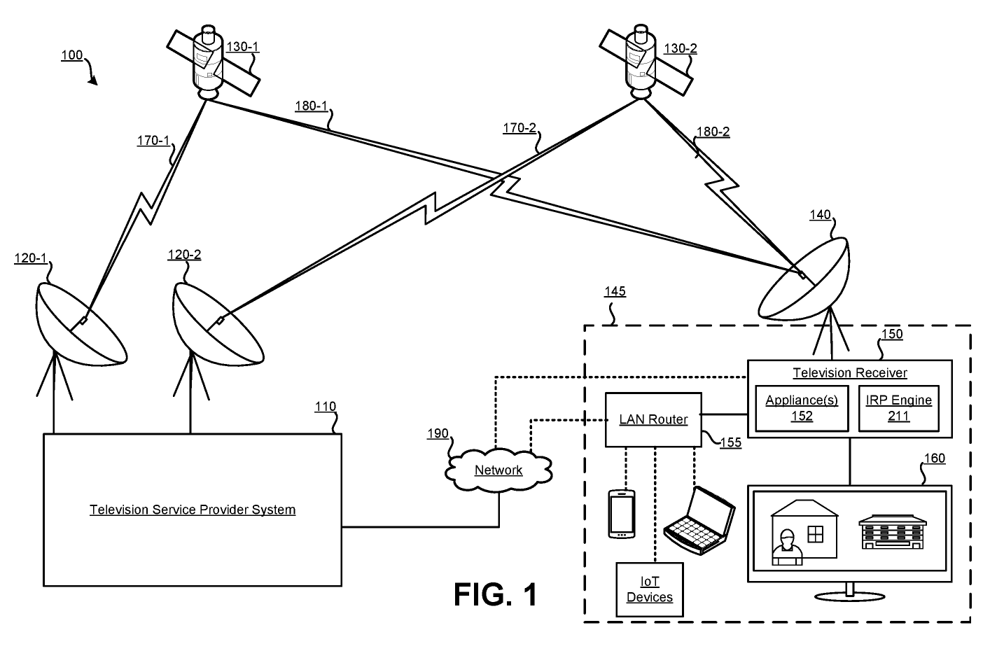

FIG. 1 shows an illustrative satellite television distribution system 100 as context for various embodiments described herein. Satellite television distribution system 100 may include: television service provider system 110, satellite transmitter equipment 120, satellites 130, satellite dish 140, television receiver 150, and display device 160. Alternate embodiments of satellite television distribution system 100 may include fewer or greater numbers of components. While only one satellite dish 140, television receiver 150, and display device 160 (collectively referred to as “user equipment”) are illustrated, it should be understood that multiple (e.g., tens, thousands, millions) instances of user equipment may receive television signals from television service provider system 110 via satellites 130. Further, while embodiments are described in particular context of a satellite television distribution system 100, techniques described herein can also be implemented in context of other television and media distribution architectures and infrastructures, such as cable television distribution networks.

The user equipment is shown disposed at a subscriber premises 145. The subscriber premises 145 can be a subscriber's home, office, or any suitable location associated with a particular subscriber at which to locate the subscriber's satellite dish 140 and television receiver 150. As one example, the satellite dish 140 is mounted to an exterior location (e.g., wall, roof, etc.) of the subscriber's home, and cables run from the satellite dish 140 to the television receiver 150, which is located inside the subscriber's home; and one or more display devices 160 (e.g., televisions) is coupled with the television receiver 150 and located in the subscriber's home.

Other user equipment can be in the subscriber's premises 145 that may or may not be directly associated with the television service provider. As illustrated, the user equipment can include a LAN router 155 in communication with the network 190. The LAN router 155 can be implemented as any suitable device or set of devices that creates a local network from the network 190 connection. For example, the LAN router 155 can include any suitable routers, switches, modems, wireless transceivers, wired ports, etc. Though described as a “LAN,” the LAN router 155 can create any suitable type of network, such as a wide-area network (WAN), a home-area network (HAN), a wireless local-area network (WLAN), etc. The LAN router 155 can be in communication with the television receiver 150 using a wired or wireless communications link. This can enable certain functions described herein, such as automatic discovery of presently unpaired devices.

The LAN router 155 can also provide local connectivity with one or more additional subscriber devices. Some such subscriber devices can be portable subscriber devices that may or may not remain in the subscriber's premises 145, such as the illustrated smart phone or laptop computer. As described herein, certain of those portable subscriber devices may be configurable as remote media playback devices using specialized coordination applications. For example, a subscriber may desire to use one or more of the portable subscriber devices to playback one or more of: live television programming received via the television receiver 150 (e.g., linearly broadcast television programming), on-demand television programming receivable via the television receiver 150, on-demand television programming locally cached by the television receiver 150, other recorded media locally cached by the television receiver 150, subscription media available via the Internet or other content distribution channels, etc.

Other subscriber devices in communication with the LAN router 155 may be non-portable, or otherwise incompatible with the types of intelligent recognition-pairing described herein. As one example, FIG. 1 illustrates the LAN router 155 in communication with a number of “Internet of Things” (IoT) devices, such as network-connected thermostats, network-connected kitchen appliances, etc. It may not be possible, or it may be otherwise undesirable, to configure some or all of such IoT devices as remote media playback devices for uses described herein (e.g., even though some such devices may be capable of certain types of media playback, or the like). As another example, a particular device communicating with the LAN router 155 at a given time may be technically compatible with types of intelligent recognition-pairing described herein, but it may not be a device of the subscriber. For instance, the device may be a mobile phone of a guest, babysitter, or other individual visiting the subscriber's premises 145.

Television service provider system 110 and satellite transmitter equipment 120 may be operated by a television service provider. A television service provider may distribute television channels, on-demand programming, programming information, and/or other content/services to users. Television service provider system 110 may receive feeds of one or more television channels from various sources. Such television channels may include multiple television channels that contain at least some of the same content (e.g., network affiliates). To distribute television channels for presentation to users, feeds of the television channels may be relayed to user equipment via multiple television distribution satellites. Each satellite may relay multiple transponder streams. Satellite transmitter equipment 120 (120-1, 120-2) may be used to transmit a feed of one or more television channels from television service provider system 110 to one or more satellites 130. While a single television service provider system 110 and satellite transmitter equipment 120 are illustrated as part of satellite television distribution system 100, it should be understood that multiple instances of transmitter equipment may be used, possibly scattered geographically, to communicate with satellites 130. Such multiple instances of satellite transmitting equipment 120 may communicate with the same or with different satellites 130. Different television channels may be transmitted to satellites 130 from different instances of transmitting equipment 120. For instance, a different satellite dish of satellite transmitter equipment 120 may be used for communication with satellites 130 in different orbital slots.

Satellites 130 may be configured to receive signals, such as streams of television channels, from one or more satellite uplinks such as satellite transmitter equipment 120. Satellites 130 may relay received signals from satellite transmitter equipment 120 (and/or other satellite transmitter equipment) to multiple instances of user equipment via transponder streams. Different frequencies may be used for uplink signals 170 from transponder streams 180. Satellites 130 may be in geosynchronous orbit. Each of the transponder streams transmitted by satellites 130 may contain multiple television channels transmitted as packetized data. For example, a single transponder stream may be a serial digital packet stream containing multiple television channels. Therefore, packets for multiple television channels may be interspersed.

Multiple satellites 130 may be used to relay television channels from television service provider system 110 to satellite dish 140. Different television channels may be carried using different satellites 130. Different television channels may also be carried using different transponders of the same satellite 130; thus, such television channels may be transmitted at different frequencies and/or different frequency ranges. As an example, a first and second television channel may be relayed via a first transponder of satellite 130-1. A third, fourth, and fifth television channel may be relayed via a different satellite or a different transponder of the same satellite relaying a transponder stream at a different frequency. A transponder stream transmitted by a particular transponder of a particular satellite may include a finite number of television channels, such as seven. Accordingly, if many television channels are to be made available for viewing and recording, multiple transponder streams may be necessary to transmit all of the television channels to the instances of user equipment. Each transponder stream may be able to carry a finite amount of data. As such, the number of television channels that can be included in a particular transponder stream may be at least partially dependent on the resolution of the video of the television channel. For example, a transponder stream may be able to carry seven or eight television channels at a high resolution, but may be able to carry dozens, fifty, a hundred, two hundred, or some other number of television channels at reduced resolutions.

Satellite dish 140 may be a piece of user equipment that is used to receive transponder streams from one or more satellites, such as satellites 130. Satellite dish 140 may be provided to a subscriber for use on a subscription basis to receive television channels provided by the television service provider system 110, satellite transmitter equipment 120, and/or satellites 130. Satellite dish 140, which may include one or more low noise blocks (LNBs), may be configured to receive transponder streams from multiple satellites and/or multiple transponders of the same satellite. Satellite dish 140 may be configured to receive television channels via transponder streams on multiple frequencies. Based on the characteristics of television receiver 150 and/or satellite dish 140, it may only be possible to capture transponder streams from a limited number of transponders concurrently. For example, a tuner of television receiver 150 may only be able to tune to a single transponder stream from a transponder of a single satellite at a given time. The tuner can then be re-tuned to another transponder of the same or a different satellite. A television receiver 150 having multiple tuners may allow for multiple transponder streams to be received at the same time.

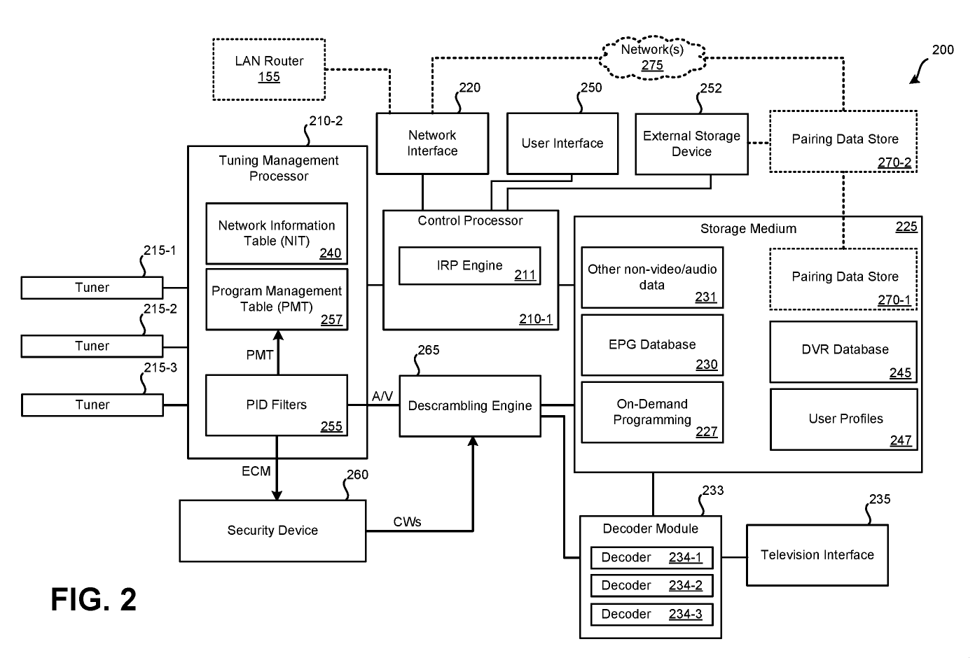

In communication with satellite dish 140 may be one or more television receivers. Television receivers may be configured to decode signals received from satellites 130 via satellite dish 140 for output and presentation via a display device, such as display device 160. A television receiver may be incorporated as part of a television or may be part of a separate device, commonly referred to as a set-top box (STB). Television receiver 150 may decode signals received via satellite dish 140 and provide an output to display device 160. FIG. 2 provides additional detail of various embodiments of a television receiver. A television receiver is defined to include set-top boxes (STBs) and also circuitry having similar functionality that may be incorporated with another device. For instance, circuitry similar to that of a television receiver may be incorporated as part of a television, and/or such circuitry can be implemented in multiple appliances. While FIG. 1 illustrates an embodiment of television receiver 150 as separate from display device 160, it should be understood that, in other embodiments, similar functions may be performed by a television receiver integrated with display device 160.

As shown, the television receiver 150 can be implemented as one or more appliances 152. For example, the television receiver 150 can include a STB and an over-the-top (OTT) appliance, a master STB in communication with distributed slave STBs (e.g., in communication via the local network of the LAN router 155 or via a separate local network enabled by the STB), etc. Though not shown, some implementations of the television receiver 150 include a modem, or the like. For example, the illustrated satellite network can be used to provide both televisions services and other communications services, such as Internet services. In such implementations, the network 190 can be implemented by the satellite communications network. For example, the output of the modem can be coupled (e.g., via a splitter) to both television receiver 150 components (e.g., a STB) and the LAN router 155. The television receiver 150 can also include an intelligent recognition-pairing (IRP) engine 211, which is described in more detail below.

Display device 160 may be used to present video and/or audio decoded and output by television receiver 150. Television receiver 150 may also output a display of one or more interfaces to display device 160, such as an electronic programming guide (EPG). In many embodiments, display device 160 is a television. Display device 160 may also be a monitor, computer, or some other device configured to display video and, possibly, play audio.

Uplink signal 170-1 represents a signal between satellite transmitter equipment 120 and satellite 130-1. Uplink signal 170-2 represents a signal between satellite transmitter equipment 120 and satellite 130-2. Each of uplink signals 170 may contain streams of one or more different television channels. For example, uplink signal 170-1 may contain a first group of television channels, while uplink signal 170-2 contains a second group of television channels. Each of these television channels may be scrambled such that unauthorized persons are prevented from accessing the television channels.

Transponder stream 180-1 represents a transponder stream signal between satellite 130-1 and satellite dish 140. Transponder stream 180-2 represents a transponder stream signal between satellite 130-2 and satellite dish 140. Each of transponder streams 180 may contain one or more different television channels, which may be at least partially scrambled. For example, transponder stream 180-1 may be a first transponder stream containing a first group of television channels, while transponder stream 180-2 may be a second transponder stream containing a different group of television channels. When a television channel is received as part of a transponder stream and is decoded and output to display device 160 (rather than first storing the television channel to a storage medium as part of DVR functionality then later outputting the television channel from the storage medium), the television channel may be considered to be viewed “live.”

FIG. 1 illustrates transponder stream 180-1 and transponder stream 180-2 being received by satellite dish 140 and distributed to television receiver 150. For a first group of television channels, satellite dish 140 may receive transponder stream 180-1 and for a second group of channels, transponder stream 180-2 may be received. Television receiver 150 may decode the received transponder streams. As such, depending on which television channels are desired to be presented or stored, various transponder streams from various satellites may be received, descrambled, and decoded by television receiver 150.

Network 190 may serve as a secondary communication channel between television service provider system 110 and television receiver 150. However, in many instances, television receiver 150 may be disconnected from network 190 (for reasons such as because television receiver 150 is not configured to connect to network 190 or a subscriber does not desire or cannot connect to network 190). As such, the connection between network 190 and television receiver 150 is represented by a dotted line. Via such a secondary communication channel, bidirectional exchange of data may occur. As such, data may be transmitted to television service provider system 110 from television receiver 150 via network 190. Data may also be transmitted from television service provider system 110 to television receiver 150 via network 190. Network 190 may be the Internet. While audio and video services may be provided to television receiver 150 via satellites 130, feedback from television receiver 150 to television service provider system 110 may be transmitted via network 190.

FIG. 2 shows an illustrative television receiver 200, according to various embodiments. Television receiver 200 may be configured to enable intelligent recognition-pairing techniques described herein. Embodiments of the television receiver 200 are implementations of the television receiver 150 of FIG. 1 (or one or more appliances 152 of the television receiver 150 of FIG. 1). For the sake of added clarity, the television receiver 200 is illustrated in context of the LAN router 155, one or more networks 275, and various implementations of a pairing data store 270; and dashed lines are used to indicate that some or all of those may be implemented separate from the television receiver 200. Television receiver 200 can be in the form of a separate device configured to be connected with a display device, such as a television; and can include one or more appliances, such as set top boxes (STBs). Additionally or alternatively, some or all of the television receiver 200 can be incorporated as part of another device, such as a television, other form of display device, video game console, computer, mobile phone or tablet, or the like. For example, a television may have an integrated television receiver (which does not involve an external STB being coupled with the television). Television receiver 200 may include: processors 210 (which may include control processor 210-1, tuning management processor 210-2, and possibly additional processors), tuners 215, network interface 220, non-transitory computer-readable storage medium 225, electronic programming guide (EPG) database 230, television interface 235, networking information table (NIT) 240, digital video recorder (DVR) database 245 (which may include provider-managed television programming storage and/or user-defined television programming), on-demand programming 227, user profiles 247, user interface 250, external storage device 252, security device 260, and/or descrambling engine 265. In other embodiments of television receiver 200, fewer or greater numbers of components may be present. It should be understood that the various components of television receiver 200 may be implemented using hardware, firmware, software, and/or some combination thereof. Functionality of components may be combined; for example, functions of descrambling engine 265 may be performed by tuning management processor 210-2. Further, functionality of components may be spread among additional components; for example, PID (packet identifier) filters 255 may be handled by separate hardware from program management table 257.

Processors 210 may include one or more specialized and/or general-purpose processors configured to perform processes such as tuning to a particular channel, accessing and displaying EPG information from EPG database 230, and/or receiving and processing input from a user. For example, processors 210 may include one or more processors dedicated to decoding video signals from a particular format, such as MPEG, for output and display on a television and for performing decryption. It should be understood that the functions performed by various modules of FIG. 2 may be performed using one or more processors. As such, for example, functions of descrambling engine 265 may be performed by control processor 210-1.

Control processor 210-1 may communicate with tuning management processor 210-2. Control processor 210-1 may control the recording of television channels based on timers stored in DVR database 245. Control processor 210-1 may also provide commands to tuning management processor 210-2 when recording of a television channel is to cease. In addition to providing commands relating to the recording of television channels, control processor 210-1 may provide commands to tuning management processor 210-2 that indicate television channels to be output to decoder module 233 for output to a display device. Control processor 210-1 may also communicate with network interface 220 and user interface 250. Control processor 210-1 may handle incoming data from network interface 220 and user interface 250. Additionally, control processor 210-1 may be configured to output data via network interface 220.

Control processor 210-1 may include an intelligent recognition-pairing (IRP) engine 211. Embodiments of the IRP engine 211 can enable novel intelligent recognition-pairing techniques described herein, such as for recognizing subscriber devices that have not downloaded and properly configured a specialized application for remote coordination between the subscriber device and the subscriber's television receiver 200. For example, the IRP engine 211 can execute a network discovery routine to discover any portable devices communicatively coupled with the LAN router 155. A pairing data store 270 can be queried box to determine whether the discovered portable device is a presently unpaired portable device with respect to a remote media playback system. In response to determining that the discovered portable device is presently unpaired with respect to the remote media playback system, a prompt can automatically be communicated directing the presently unpaired portable device to pair with the remote media playback system. The IRP engine 211 is described more fully below.

Tuners 215 may include one or more tuners used to tune to transponders that include broadcasts of one or more television channels. In the illustrated embodiment of television receiver 200, three tuners are present (tuner 215-1, tuner 215-2, and tuner 215-3). In other embodiments, two or more than three tuners may be present, such as four, six, or eight tuners. Each tuner contained in tuners 215 may be capable of receiving and processing a single transponder stream from a satellite transponder at a given time. As such, a single tuner may tune to a single transponder stream at a given time. If tuners 215 include multiple tuners, one tuner may be used to tune to a television channel on a first transponder stream for display using a television, while another tuner may be used to tune to a television channel on a second transponder for recording and viewing at some other time. If multiple television channels transmitted on the same transponder stream are desired, a single tuner of tuners 215 may be used to receive the signal containing the multiple television channels for presentation and/or recording. Tuners 215 may receive commands from tuning management processor 210-2. Such commands may instruct tuners 215 which frequencies are to be tuned to.

Network interface 220 may be used to communicate via an alternate communication channel with a television service provider, if such communication channel is available. The primary communication channel may be via satellite (which may be unidirectional to television receiver 200) and the alternate communication channel (which may be bidirectional) may be via one or more networks 275, such as the Internet. For example, as described with reference to FIG. 1, television receiver 150 may be able to communicate with television service provider system 110 via a network 190, such as the Internet. This communication may be bidirectional: data may be transmitted from television receiver 150 to television service provider system 110 and from television service provider system 110 to television receiver 150. Any suitable information may be transmitted and/or received via network interface 220. For instance, instructions (e.g., regarding subscription portability) from a television service provider may also be received via network interface 220, if connected with the Internet. Network interface 220 may be used to provide a confirmation to a television service provider that instructions received from the television service provider have indeed been executed.

Further as described with reference to FIG. 1, the network interface 220 can be communicatively coupled (e.g., via one or more networks 275, directly, or in any other suitable manner) with the LAN router 155. As described herein, communications between the television receiver 200 and the LAN router 155 can help facilitate intelligent recognition-pairing techniques described herein. Also as described herein, various intelligent recognition-pairing techniques exploit data maintained in a pairing data store 270. The pairing data store 270 can be implemented in any suitable manner, such that the data is accessible for use in performing the intelligent recognition-pairing techniques. In one implementation, the pairing data store 270 is implemented on-board the television receiver 200, for example, in the storage medium 225 of the television receiver 200 (illustrated as pairing data store 270-1). In another implementation, the pairing data store 270 is implemented in an external storage device 252 of the television receiver 200. In another implementation, the pairing data store 270 is accessible via the network interface 220 and one or more networks 275. For example, the pairing data store 270 is implemented on a remote server, a cloud storage system, or the like. External implementations of the pairing data store 270 are illustrated as pairing data store 270-2.

Storage medium 225 may represent one or more non-transitory computer-readable storage mediums. Storage medium 225 may include memory and/or a hard drive. Storage medium 225 may be used to store information received from one or more satellites and/or information received via network interface 220. Storage medium 225 may store information related to EPG database 230, other non-video/audio data 231, DVR database 245, user profiles 247, and/or on-demand programming 227. Recorded television programs may be stored using storage medium 225 as part of DVR database 245. Storage medium 225 may be partitioned or otherwise divided (such as into folders) such that predefined amounts of storage medium 225 are devoted to storage of television programs recorded due to user-defined timers and stored television programs recorded due to provider-defined timers.

EPG database 230 may store information related to television channels and the timing of programs appearing on such television channels. EPG database 230 may be stored using storage medium 225, which may be a hard drive. Information from EPG database 230 may be used to inform users of what television channels or programs are popular and/or provide recommendations to the user. Information from EPG database 230 may provide the user with a visual interface displayed by a television that allows a user to browse and select television channels and/or television programs for viewing and/or recording. Information used to populate EPG database 230 may be received via network interface 220 and/or via satellites, such as satellites 130 of FIG. 1 via tuners 215. For instance, updates to EPG database 230 may be received periodically via satellite. EPG database 230 may serve as an interface for a user to control DVR functions of television receiver 200, and/or to enable viewing and/or recording of multiple television channels simultaneously.

The network information table (NIT) 240 may store information used by television receiver 200 to access various television channels. NIT 240 may be stored locally by a processor, such as tuning management processor 210-2 and/or by storage medium 225. Information used to populate NIT 240 may be received via satellite (or cable) through tuners 215 and/or may be received via network interface 220 from the television service provider. As such, information present in NIT 240 may be periodically updated. In some embodiments, NIT 240 may be locally-stored by television receiver 200 using storage medium 225. Generally, NIT 240 may store information about a service provider network, such as a satellite-based service provider network. Information that may be present in NIT 240 may include: television channel numbers, satellite identifiers (which may be used to ensure different satellites are tuned to for reception of timing signals), frequency identifiers and/or transponder identifiers for various television channels. In some embodiments, NIT 240 may contain additional data or additional tables may be stored by the television receiver. For example, while specific audio PIDs and video PIDs may not be present in NIT 240, a channel identifier may be present within NIT 240 which may be used to look up the audio PIDs and video PIDs in another table, such as a program map table (PMT). In some embodiments, a PID associated with the data for the PMT is indicated in a separate table, program association table (PAT), which is not illustrated in FIG. 2. A PAT may be stored by the television receiver in a similar manner to the NIT. For example, a PMT may store information on audio PIDs, and/or video PIDs. A PMT stores data on ECM (entitlement control message) PIDs for television channels that are transmitted on a transponder frequency. If, for a first television channel, multiple television channels are to be tuned to, NIT 240 and/or PMT 257 may indicate a second television channel that is to be tuned to when a first channel is tuned to.

Based on information in the NIT, it may be possible to determine the proper satellite and transponder to which to tune for a particular television channel. In some embodiments, the NIT may list a particular frequency to which to tune for a particular television channel. Once tuned to the proper satellite/transponder/frequency, the PMT PID may be used to retrieve a program management table that indicates the PIDs for audio and video streams of television channels transmitted by that transponder.

While a large portion of storage space of storage medium 225 is devoted to storage of television programming, a portion may be devoted to storage of non-audio/video data, such as EPG database 230 and other non-video/audio data 231. This “other” data may permit television receiver 200 to function properly. In some embodiments, at least ten gigabytes are allocated to such other data. For example, if NIT 240 is stored by storage medium 225, it may be part of other non-video/audio data 226.

User profiles 247 may include stored user preferences. For example, a user may specify a preferred category of television programming, such as: sports, news, movies, sitcoms, reality, etc. The user may also specify whether they prefer broadcast (“live”) television, on-demand programming, or recorded television programming (via user or provider-defined timers). In some embodiments, data for a user's profile may be defined based on measured viewing habits, such as which television channels and/or categories of television programming does the user watch. User profiles 247 may specify which television programs were recorded based on timers set by the user associated with a specific user profile. User profiles 247 may include profiles for multiple users or may include a single profile for the television receiver in general. In some embodiments, a user is permitted to select which user profile of user profiles 247 is active. For instance, a user can log on to television receiver 200. In other embodiments, the television receiver 200 may be configured to identify a user and select a user profile 247 for use automatically, such as through facial recognition using an associated image capture device, biometric recognition, such as a fingerprint detection device incorporated into a remote control or identification through devices carried on a person, such as RFID, NFC cards or pairing to a mobile communication device.

Decoder module 233 may serve to convert encoded video and audio into a format suitable for output to a display device. For instance, decoder module 233 may receive MPEG video and audio from storage medium 225 or descrambling engine 265 to be output to a television. MPEG video and audio from storage medium 225 may have been recorded to DVR database 245 as part of a previously-recorded television program. Decoder module 233 may convert the MPEG video and audio into a format appropriate to be displayed by a television or other form of display device and audio into a format appropriate to be output from speakers, respectively. Decoder module 233 may have the ability to convert a finite number of television channel streams received from storage medium 225 or descrambling engine 265, simultaneously. For instance, each of decoders 234 within decoder module 233 may be able to only decode a single television channel at a time. While decoder module 233 is illustrated as having three decoders 234 (decoder 234-1, decoder 234-2, and decoder 234-3), in other embodiments, a greater or fewer number of decoders may be present in television receiver 200. A decoder may be able to only decode a single high definition television program at a time. However, a decoder may be able to decode multiple preview clips at the same time.

Television interface 235 may serve to output a signal to a television (or another form of display device) in a proper format for display of video and playback of audio. As such, television interface 235 may output one or more television channels, stored television programming from storage medium 225 (e.g., television programs from DVR database 245, television programs from on-demand programming 230 and/or information from EPG database 230) to a television for presentation.

Digital Video Recorder (DVR) functionality may permit a television channel to be recorded for a period of time. DVR functionality of television receiver 200 may be managed by control processor 210-1. Control processor 210-1 may coordinate the television channel, start time, and stop time of when recording of a television channel is to occur. DVR database 245 may store information related to the recording of television channels. DVR database 245 may store timers that are used by control processor 210-1 to determine when a television channel should be tuned to and its programs recorded to DVR database 245 of storage medium 225. In some embodiments, a limited amount of storage medium 225 may be devoted to DVR database 245. Timers may be set by the television service provider and/or one or more users of television receiver 200.

DVR database 245 may also be used to record recordings of service provider-defined television channels. For each day, an array of files may be created. For example, based on provider-defined timers, a file may be created for each recorded television channel for a day. For example, if four television channels are recorded from 6-10 PM on a given day, four files may be created (one for each television channel). Within each file, one or more television programs may be present. The service provider may define the television channels, the dates, and the time periods for which the television channels are recorded for the provider-defined timers. The provider-defined timers may be transmitted to television receiver 200 via the television provider's network. For example, referring to satellite television distribution system 100 of FIG. 1, in a satellite-based television service provider system, data necessary to create the provider-defined timers at television receiver 150 may be received via satellite.

As an example of DVR functionality of television receiver 200 being used to record based on provider-defined timers, a television service provider may configure television receiver 200 to record television programming on multiple, predefined television channels for a predefined period of time, on predefined dates. For instance, a television service provider may configure television receiver 200 such that television programming may be recorded from 7 to 10 PM on NBC, ABC, CBS, and FOX on each weeknight and from 6 to 10 PM on each weekend night on the same channels. These channels may be transmitted as part of a single transponder stream such that only a single tuner needs to be used to receive the television channels. Packets for such television channels may be interspersed and may be received and recorded to a file. If a television program is selected for recording by a user and is also specified for recording by the television service provider, the user selection may serve as an indication to save the television program for an extended time (beyond the time which the predefined recording would otherwise be saved). Television programming recorded based on provider-defined timers may be stored to a portion of storage medium 225 for provider-managed television programming storage.

DVR Database 245 may also store television programming that is recorded based on analysis of user profiles 247. For instance, if a user frequently watches and/or records sports, a major sporting event may be selected by control processor 210-1 for recording based on the user's profile. The day of the week, channel, and/or time of previously set timers may also be used to record television programming. For instance, if a user has previously set a timer to record television channel five at 8 PM on Thursdays, control processor 210-1 may set a timer for this same day of the week, channel, and time for some point in the future (even though the user has not specifically selected it).

On-demand programming 227 may represent additional television programming stored by storage medium 225. On-demand programming 227 may include television programming that was not recorded to storage medium 225 via a timer (either user- or provider-defined). Rather, on-demand programming is programming provided to the television receiver directly for storage by the television receiver and for later presentation to one or more users. On-demand programming may not be user-selected. As such, the television programming stored to on-demand programming storage 227 may be the same for each television receiver of a television service provider.

User interface 250 may include a remote control (physically separate from television receiver 200) and/or one or more buttons on television receiver 200 that allow a user to interact with television receiver 200. User interface 250 may be used to select a television channel for viewing, view information from EPG database 230, and/or program a timer stored to DVR database 245, wherein the timer is used to control the DVR functionality of control processor 210-1. In some embodiments, it may be possible to load some or all preferences to a remote control. As such, the remote control can serve as a backup storage device for the preferences.

Referring back to tuners 215, television channels received via satellite (or cable) may contain at least some scrambled data. Packets of audio and video may be scrambled to prevent unauthorized users (e.g., nonsubscribers) from receiving television programming without paying the television service provider. When a tuner of tuners 215 is receiving data from a particular transponder of a satellite, the transponder stream may be a series of data packets corresponding to multiple television channels. Each data packet may contain a packet identifier (PID), which, in combination with NIT 240 and/or PMT 257, can be determined to be associated with a particular television channel. Particular data packets, referred to as entitlement control messages (ECMs), may be periodically transmitted. ECMs may be associated with another PID and may be encrypted; television receiver 200 may use decryption engine 261 of security device 260 to decrypt ECMs. Decryption of an ECM may only be possible if the user has authorization to access the particular television channel associated with the ECM. When an ECM is determined to correspond to a television channel being stored and/or displayed, the ECM may be provided to security device 260 for decryption.

When security device 260 receives an encrypted ECM, security device 260 may decrypt the ECM to obtain some number of control words. In some embodiments, from each ECM received by security device 260, two control words are obtained. In some embodiments, when security device 260 receives an ECM, it compares the ECM to the previously received ECM. If the two ECMs match, the second ECM is not decrypted because the same control words would be obtained. In other embodiments, each ECM received by security device 260 is decrypted; however, if a second ECM matches a first ECM, the outputted control words will match; thus, effectively, the second ECM does not affect the control words output by security device 260. Security device 260 may be permanently part of television receiver 200 or may be configured to be inserted and removed from television receiver 200, such as a smart card, cable card or the like.

Tuning management processor 210-2 may be in communication with tuners 215 and control processor 210-1. Tuning management processor 210-2 may be configured to receive commands from control processor 210-1. Such commands may indicate when to start/stop receiving and/or recording of a television channel and/or when to start/stop causing a television channel to be output to a television. Tuning management processor 210-2 may control tuners 215. Tuning management processor 210-2 may provide commands to tuners 215 that instruct the tuners which satellite, transponder, and/or frequency to tune to. From tuners 215, tuning management processor 210-2 may receive transponder streams of packetized data. As previously detailed, some or all of these packets may include a PID that identifies the content of the packet.

Tuning management processor 210-2 may be configured to create one or more PID filters 255 that sort packets received from tuners 215 based on the PIDs. When a tuner is initially tuned to a particular frequency (e.g., to a particular transponder of a satellite), a PID filter may be created based on the PMT data. The PID created, based on the PMT data packets, may be known because it is stored as part of NIT 240 or another table, such as a program association table (PAT). From the PMT data packets, PMT may be constructed by tuning management processor 210-2.

PID filters 255 may be configured to filter data packets based on PIDs. In some embodiments, PID filters 255 are created and executed by tuning management processor 210-2. For each television channel to be output for presentation or recording, a separate PID filter may be configured. In other embodiments, separate hardware may be used to create and execute such PID filters. Depending on a television channel selected for recording/viewing, a PID filter may be created to filter the video and audio packets associated with the television channel (based on the PID assignments present in PMT 257). For example, if a transponder data stream includes multiple television channels, data packets corresponding to a television channel that is not desired to be stored or displayed by the user may be ignored by PID filters 255. As such, only data packets corresponding to the one or more television channels desired to be stored and/or displayed may be filtered and passed to either descrambling engine 265 or security device 260; other data packets may be ignored. For each television channel, a stream of video packets, a stream of audio packets (one or both of the audio programs) and/or a stream of ECM packets may be present, each stream identified by a PID. In some embodiments, a common ECM stream may be used for multiple television channels. Additional data packets corresponding to other information, such as updates to NIT 240, may be appropriately routed by PID filters 255. At a given time, one or multiple PID filters may be executed by tuning management processor 210-2.

Similar to a PID filter being created for a particular television channel, a PID filter may be created for timing signals for use in determining the location of the television receiver.

Descrambling engine 265 may use the control words output by security device 260 in order to descramble video and/or audio corresponding to television channels for storage and/or presentation. Video and/or audio data contained in the transponder data stream received by tuners 215 may be scrambled. Video and/or audio data may be descrambled by descrambling engine 265 using a particular control word. Which control word output by security device 260 to be used for successful descrambling may be indicated by a scramble control identifier present within the data packet containing the scrambled video or audio. Descrambled video and/or audio may be output by descrambling engine 265 to storage medium 225 for storage (in DVR database 245) and/or to decoder module 233 for output to a television or other presentation equipment via television interface 235.

External storage device 252 may represent an external, detachable computer-readable non-transitory storage device. The storage device may be memory, a hard drive, or some other type of device for storing computer-readable data. The user may be permitted to connect and disconnect external storage device 252 to increase and decrease an amount of storage space available for storing on-demand programming, service provider-managed television programming, and/or user managed television programming.

For simplicity, television receiver 200 of FIG. 2 has been reduced to a block diagram; commonly known parts, such as a power supply, have been omitted. Further, some routing between the various modules of television receiver 200 has been illustrated. Such illustrations are for exemplary purposes only. The state of two modules not being directly or indirectly connected does not indicate the modules cannot communicate. Rather, connections between modules of the television receiver 200 are intended only to indicate possible common data routing. It should be understood that the modules of television receiver 200 may be combined into a fewer number of modules or divided into a greater number of modules. Further, the components of television receiver 200 may be part of another device, such as built into a television. Television receiver 200 may include one or more instances of various computerized components, such as disclosed in relation to computer system 800 of FIG. 8.

While the television receiver 200 has been illustrated as a satellite receiver, it is to be appreciated that techniques below may be implemented in other types of television receiving devices, such a cable receivers, terrestrial receivers, IPTV receivers or the like. In some embodiments, the television receiver 200 may be configured as a hybrid receiving device, capable of receiving content from disparate communication networks, such as satellite and terrestrial television broadcasts. In some embodiments, the tuners may be in the form of network interfaces capable of receiving content from designated network locations.

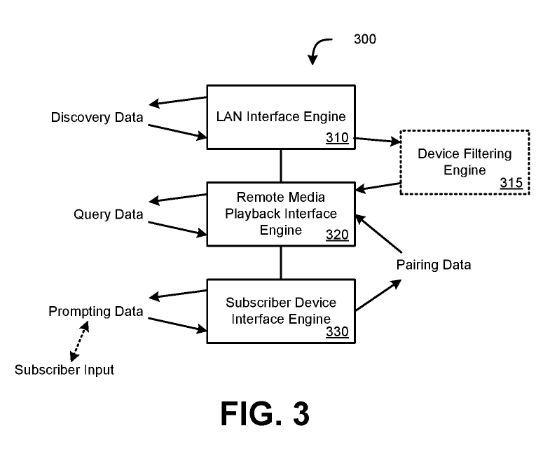

FIG. 3 shows an illustrative implementation of an intelligent recognition-pairing (IRP) engine 300, according to various embodiments. The IRP engine 300 can be an implementation of the IRP engine 211 of FIG. 2, and the IRP engine 300 can be implemented as one or more processors, one or more state machines, or in any other suitable manner. In an intelligent recognition-pairing state, the IRP engine 300 can seek to recognize presently unpaired portable subscriber devices and to encourage pairing of those devices. As illustrated, the IRP engine 300 can include a LAN interface engine 310, a remote media playback (RMP) interface engine 320, and a subscriber device interface engine 330.

Embodiments of the LAN interface engine 310 can execute a network discovery routine (e.g., a UDP discovery routine) to discover whether a portable device is communicatively coupled with the LAN. For example, the LAN interface engine 310 is in communication with a LAN router, or the like. The LAN interface engine 310 can execute the network discovery routine by communicating discovery data with the LAN router, such as transmitting requests for information regarding devices presently in communication with the LAN router, and receiving responses from the LAN router accordingly.

Embodiments of the RMP interface engine 320 can be responsive to (e.g., triggered by) the network discovery routine discovering one or more portable devices communicatively coupled with the LAN. The RMP interface engine 320 can query a pairing data store to determine whether the one or more discovered portable devices is a presently unpaired portable device with respect to a RMP system. The RMP system can be any suitable set of components to facilitate remote playback of media available via the subscriber's television receiver (e.g., and additional media, in some implementations). For example, the RMP system can be implemented by an OTT appliance that is part of, or in communication with, a set-top box.

Embodiments of the subscriber device interface engine 330 can communicate with the one or more devices that are detected and determined to be presently unpaired. The subscriber device interface engine 330 can be responsive to the query determining that the discovered portable device is a presently unpaired portable device, and can automatically communicate a prompt to the presently unpaired portable device in such instances. The prompt can direct the presently unpaired portable device to pair with the remote media playback system, for example, by providing a reminder, a link, or the like.

In some implementations, the IRP engine 300 also includes a device filtering engine 315. For example, at any particular time, some devices may be communicatively coupled with a LAN router of the subscriber's premises, but those devices may not be compatible for IRP with the RMP system. The device filtering engine 315 can determine when the detected devices are not compatible, and can direct the IRP engine 300 to ignore those devices for IRP functions. For example, the device filtering engine 315 can direct the RMP interface engine 320 not to issue a query for such devices, or can direct the RMP interface engine 320 to query only those devices determined by the device filtering engine 315 to be RMP-compatible. In some implementations, the device filtering engine 315 can direct logging of incompatible devices to improve future recognition of those RMP-compatible devices. For example, the device filtering engine 315 can maintain a blacklist of devices that have previously been recognized and determined to be RMP-incompatible. Different implementations can consider RMP-compatibility in different ways. Some implementations can seek to determine whether a detected device is portable ; and the device filtering engine 315 can consider only portable devices to be RMP-compatible. Such filtering can help avoid attempts to encourage pairing of devices that are substantially fixed within the subscriber premises, such as many IoT home automation devices, or the like, which are not going to be used by the subscriber for remote media playback outside the subscriber premises. Other implementations can seek to determine whether a detected device is associated with a particular subscriber (e.g., the subscriber associated with the television receiver in which the IRP engine 300 is deployed); and the device filtering engine 315 can consider only the subscriber's devices to be RMP-compatible. Such filtering can help avoid attempts to encourage pairing of devices that will not have authorization to access the subscriber's content.

In some instances, the prompt communicated by the subscriber device interface engine 330 results in a user of the device (e.g., the subscriber) configuring the device for pairing with the RMP system. For example, the subscriber device interface engine 330 can receive a pairing indication in response to the presently unpaired portable device completing a pairing interaction with the RMP system. In one implementation, the pairing interaction includes the user clicking on a link provided in the prompt, thereby facilitating the user downloading a RMP coordination application to the presently unpaired portable device, executing the application, and configuring the application for pairing with the RMP system. When the portable device has paired with the RMP system (e.g., when the application has been downloaded and/or configured, and/or at any suitable associated time), embodiments can update the pairing data store to indicate the presently unpaired portable device as a paired portable device. For example, the pairing interactions can be between the portable device and the RMP interface engine 320 (e.g., via the subscriber device interface engine 330), and the RMP interface engine 320 can direct updating of the pairing data store.

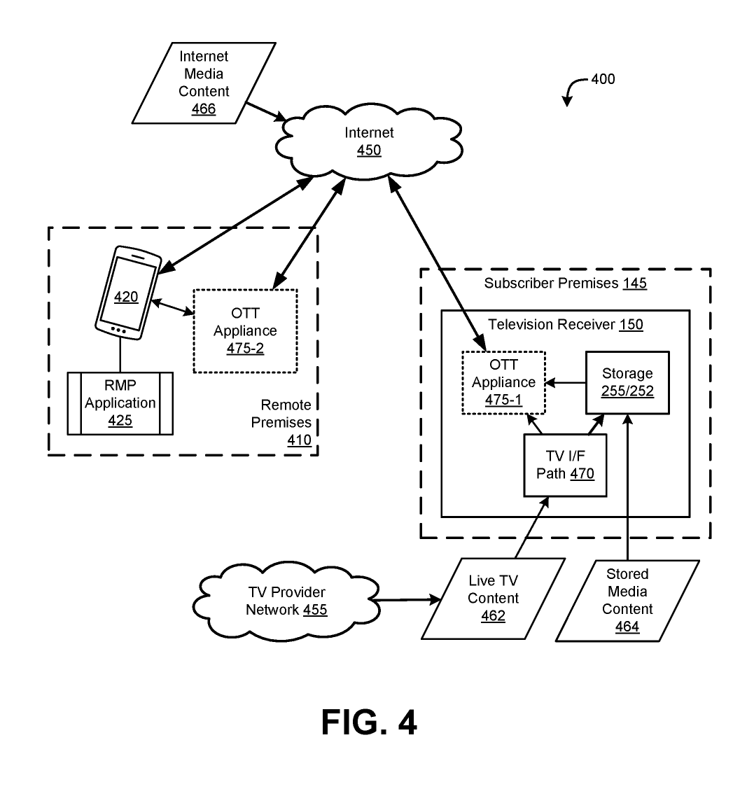

FIG. 4 shows an illustrative remote media playback environment 400 that facilitates remote playback by a paired portable device 420 of subscription and/or other media, according to various embodiments. The environment 400 shows a subscriber premises 145 (e.g., as in FIG. 1) having a television receiver 150. As described above (e.g., with reference to FIGS. 1 and 2), the television receiver 150 can include components to facilitate receipt , delivery, and storage of television and other media. For example, embodiments of the television receiver 150 are in communication with a television provider network 455 (e.g., a satellite network), from which it receives live television content 462, such as linear broadcasting content, streaming on-demand content, etc. The television receiver 150 can include a television interface path 470 that generally includes any suitable components for tuning, filtering, decoding, descrambling, and otherwise preparing the received signals into usable live television content 462. The live television content 462 and/or other content (e.g., streaming Internet content) can be delivered by the television receiver 150 to playback devices (e.g., televisions), storage devices (e.g., storage medium 255 and/or external storage 252), and/or other internal or external appliances. The television receiver 150 can implement an OTT appliance 475 (e.g., one of the appliances 152 of FIG. 1). The OTT appliance 475 can be implemented as part of a set-top box, as a dedicated appliance, or in any other suitable manner. The OTT appliance 475 can effectively convert the television receiver 150 (e.g., and additional components) into a remote media playback system by providing OTT access to the live television content 462 and/or locally stored media content 464 (e.g., in the local storage devices of the television receiver 150).

The remote media playback environment 400 also includes a remote premises 410 from which the subscriber desires to access subscription content. It is assumed that the illustrated portable device 420 has been paired with the RMP system, for example, as described with reference to FIG. 3. As such, the paired portable device 420 has a RMP application 425 that has previously been configured (e.g., as part of the pairing process) to coordinate with the RMP system (e.g., with the OTT appliance 475) for remote playback of at least some subscription content. In some implementations, configuration of the RMP application 425 involves the RMP application 425 gaining access to certain keys, or other information to aid in decoding, descrambling, or other authentication of the portable device 420 with respect to the subscription content. For example, certain authentication codes for subscription content can include the ECMs, CWs, and/or other codes, when can be further encoded by one or more secondary keys (e.g., updated periodically). The RMP application 425 can have the secondary key(s). In such a way, the paired portable device 420 can use the RMP application 425 to access the OTT appliance 475 over the Internet 450 (or any suitable network), thereby remotely playing back subscription content.

Some implementations include additional features. For example, some RMP applications 425 can include a proprietary media player that includes support for proprietary encryption, encoding, and/or other schemes. Other RMP applications 425 can include embedded players, such as enabled by HTMLS. Some implementations of the RMP application 425 can play some or all subscription content, including some or all live television content 462 and/or stored media content 464. Some can additionally play other types of content, such as content stored local to the portable device 420, Internet media content (e.g., streaming media from Internet media providers), etc.

Some embodiments include a portable OTT appliance 475-2. For example, the portable OTT appliance 475-2 can be used as remote storage for a certain portion of the subscriber's content. In some implementations, the portable OTT appliance 475-2 can communicatively couple with the television receiver 150 when in a LAN with the television receiver 150 and/or over the Internet 450. The portable OTT appliance 475-2 can store subscription content using any suitable encoding and/or encryption, for example in the same way as used by the television receiver 150. In such embodiments, the portable device 420 can communicate directly with the portable OTT appliance 475-2 for remote media playback. For example, where the subscriber at the remote premises 410 has poor or no communication with the Internet 450, the portable OTT appliance 475-2 can be used to provide offline OTT services.

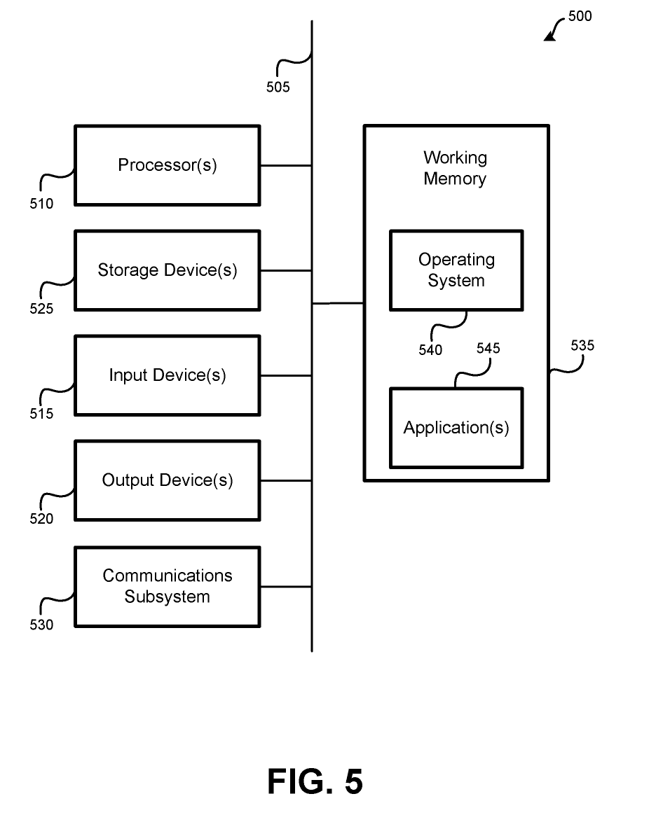

A computer system as illustrated in FIG. 5 may be incorporated as part of the previously described computerized devices, such as the television receivers. FIG. 5 provides a schematic illustration of one embodiment of a computer system 500 that can perform various steps of the methods provided by various embodiments. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as digital signal processing chips, graphics acceleration processors, video decoders, and/or the like); one or more input devices 515, which can include, without limitation, a mouse, a keyboard, remote control, and/or the like; and one or more output devices 520, which can include, without limitation, a display device, a printer, and/or the like.

The computer system 500 may further include (and/or be in communication with) one or more non-transitory storage devices 525, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including, without limitation, various file systems, database structures, and/or the like.

The computer system 500 might also include a communications subsystem 530, which can include, without limitation, a modem, a network card (wireless or wired), an infrared communication device, a wireless communication device, and/or a chipset (such as a Bluetooth™ device, an 502.11 device, a WiFi device, a WiMax device, cellular communication device, etc.), and/or the like. The communications subsystem 530 may permit data to be exchanged with a network (such as the network described below, to name one example), other computer systems, and/or any other devices described herein. In many embodiments, the computer system 500 will further comprise a working memory 535, which can include a RAM or ROM device, as described above.

The computer system 500 also can comprise software elements, shown as currently being located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or codes might be stored on a non-transitory computer-readable storage medium, such as the non-transitory storage device(s) 525 described above. In some cases, the storage medium might be incorporated within a computer system, such as computer system 500. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices, such as network input/output devices, may be employed.

As mentioned above, in one aspect, some embodiments may employ a computer system (such as the computer system 500) to perform methods in accordance with various embodiments of the invention. According to a set of embodiments, some or all of the procedures of such methods are performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another computer-readable medium, such as one or more of the non-transitory storage device(s) 525. Merely by way of example, execution of the sequences of instructions contained in the working memory 535 might cause the processor(s) 510 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computer system 500, various computer-readable media might be involved in providing instructions/code to processor(s) 510 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 525. Volatile media include, without limitation, dynamic memory, such as the working memory 535.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500.

The communications subsystem 530 (and/or components thereof) generally will receive signals, and the bus 505 then might carry the signals (and/or the data, instructions, etc., carried by the signals) to the working memory 535, from which the processor(s) 510 retrieves and executes the instructions. The instructions received by the working memory 535 may optionally be stored on a non-transitory storage device 525 either before or after execution by the processor(s) 510.

It should further be understood that the components of computer system 500 can be distributed across a network. For example, some processing may be performed in one location using a first processor while other processing may be performed by another processor remote from the first processor. Other components of computer system 500 may be similarly distributed. As such, computer system 500 may be interpreted as a distributed computing system that performs processing in multiple locations. In some instances, computer system 500 may be interpreted as a single computing device, such as a distinct laptop, desktop computer, or the like, depending on the context.

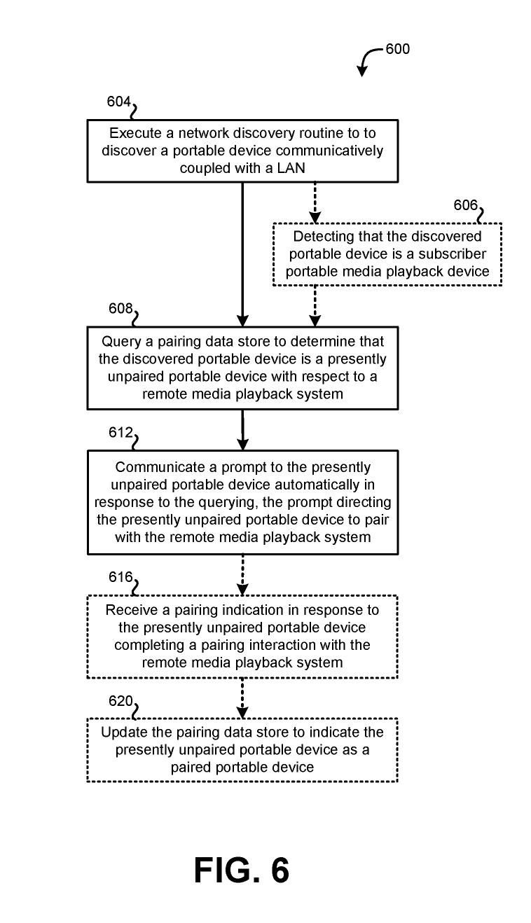

Systems including those described above can be used to implement various methods 600. FIG. 6 shows a flow diagram of an illustrative method 600 for driving recognition-pairing of a portable device with a remote media playback system. Embodiments of the method 600 begin at stage 604 by executing a network discovery routine to discover a portable device communicatively coupled with a local-area network (LAN). For example, the executing can be performed by a television receiver communicatively coupled with a LAN router. In some implementations, the network discovery routine is, or includes, a User Datagram Protocol discovery routine.

At stage 608, embodiments can query a pairing data store by the television receiver to determine that the discovered portable device is a presently unpaired portable device with respect to the remote media playback system. The pairing data store can be stored local to the television receiver, in cloud-based storage, or in any other suitable manner. The discovered portable device can be determined as a presently unpaired portable device when the pairing data store indicates that the device has never downloaded a particular RMP application, that the RMP application is outdated, that the RMP application has never been configured or logged into, that the RMP application configuration is outdated, that the RMP application has remained unused for a predetermined threshold amount of time, etc.

In some embodiments, the querying at stage 608 occurs only in response to detecting, at stage 606, that the discovered portable device is a subscriber portable media playback device. As described above, such discovery can involve any suitable detection that the device is RMP-compatible. In one implementation, detecting that the discovered portable device is a subscriber portable media playback device comprises detecting that a device type of the discovered portable device is compatible with an executable application configured to pair with the remote media playback system. For example, such detection can involve determining that the device is a portable device with media playing capability, which can include determining a device type, processing speed, graphics capability, screen size, protocol support, etc. In another implementation, detecting that the discovered portable device is a subscriber portable media playback device comprises detecting that at least a predetermined threshold amount of communications has occurred between the discovered portable device and the LAN router. For example, the device can be considered RMP-compatible only after it is detected that the device has communicated at least a minimum amount of data with the LAN, has been communicating with the LAN for at least a certain amount of time (e.g., in a single contiguous timespan, total over a time period, etc.). has been communicating certain types of data with the LAN (e.g., media file types, etc.), etc.

At stage 612, embodiments can communicate a prompt to the presently unpaired portable device automatically in response to the querying. The prompt directs the presently unpaired portable device to pair with the remote media playback system. In some implementations, communicating the prompt includes communicating a clickable link for display via a graphical user interface of the presently unpaired portable device. In such implementations, activating the clickable link initiates a pairing routine to pair the presently unpaired portable device with the remote media playback system. Though described as “clickable,” the link can generally be any suitable type of graphical or other interface element that facilitates interaction between the device user and the pairing.

In some embodiments, at stage 616, a pairing indication can be received in response to the presently unpaired portable device completing a pairing interaction with the remote media playback system. For example, the prompt communicated in stage 612 can include a reminder, instructions, a link, or any suitable prompt to encourage a user of the receiving device to initiate pairing. By following the instructions, clicking the link, and/or otherwise interacting with the prompt, the user can configure the device for use with the RMP system. For example, the pairing interactions can include downloading an application and configuring the application for use with the subscriber's television receiver, OTT appliance, account, etc. In such embodiments, at stage 620, the pairing data store can be updated to indicate the presently unpaired portable device as a paired portable device.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A television receiver comprising:
one or more processors; and
a memory communicatively coupled with, and readable by, the one or more processors and having stored therein processor-readable instructions which, when executed by the one or more processors, cause the one or more processors to:
communicatively couple with a local-area network (LAN);
execute a network discovery routine to discover whether a portable device is communicatively coupled with the LAN;
query a pairing data store, in response to the network discovery routine discovering that the portable device is communicatively coupled with the local-area network, to determine whether the discovered portable device is a presently unpaired portable device with respect to a remote media playback system associated with the television receiver; and
communicate a prompt to the presently unpaired portable device, automatically in response to the query determining that the discovered portable device is a presently unpaired portable device, the prompt directing the presently unpaired portable device to pair with the remote media playback system.

2. The television receiver of claim 1, wherein the processor-readable instructions, when executed by the one or more processors, cause the one or more processors further to:
receive a pairing indication in response to the presently unpaired portable device completing a pairing interaction with the remote media playback system; and
update the pairing data store to indicate the presently unpaired portable device as a paired portable device.

3. The television receiver of claim 1, wherein the processor-readable instructions, when executed by the one or more processors, cause the one or more processors further to:
detect that the discovered portable device is a subscriber portable media playback device,
wherein the one or more processors query in response to the detecting.

4. The television receiver of claim 1, wherein the one or more processors is disposed in a set-top box configured to be coupled with a television service provider system.

5. The television receiver of claim 1, wherein memory further has stored therein the pairing data store.

6. A method for driving recognition-pairing of a portable device with a remote media playback system, the method comprising:
executing a network discovery routine by a television receiver communicatively coupled with a local area network (LAN) router, the executing comprising discovering a portable device communicatively coupled with the LAN router;
querying a pairing data store by the television receiver to determine that the discovered portable device is a presently unpaired portable device with respect to the remote media playback system; and
communicating a prompt to the presently unpaired portable device automatically in response to the querying, the prompt directing the presently unpaired portable device to pair with the remote media playback system.

7. The method of claim 6, further comprising:
receiving a pairing indication in response to the presently unpaired portable device completing a pairing interaction with the remote media playback system; and
updating the pairing data store to indicate the presently unpaired portable device as a paired portable device.

8. The method of claim 6, further comprising:
detecting that the discovered portable device is a subscriber portable media playback device,
wherein the querying is performed in response to the detecting.

9. The method of claim 8, wherein detecting that the discovered portable device is a subscriber portable media playback device comprises detecting that a device type of the discovered portable device is compatible with an executable application configured to pair with the remote media playback system.

10. The method of claim 8, wherein detecting that the discovered portable device is a subscriber portable media playback device comprises detecting that at least a predetermined threshold amount of communications has occurred between the discovered portable device and the LAN router.

11. The method of claim 6, wherein the network discovery routine comprises a User Datagram Protocol discovery routine.

12. The method of claim 6, wherein the television receiver houses the pairing data store.

13. The method of claim 6, wherein:
the television receiver is coupled via a communications network with cloud backend storage comprising the pairing data store; and
querying the pairing data store comprises communicating a pairing query request to the pairing data store via the communications network and receiving a pairing query response from the pairing data store via the communications network.

14. The method of claim 6, wherein the remote media playback system comprises a media playback application executable via the presently unpaired portable device.

15. The method of claim 14, wherein the discovered portable device is discovered to be presently unpaired with respect to the remote media playback system when the pairing data store indicates that the discovered portable device has not downloaded the media playback application.

16. The method of claim 14, wherein the discovered portable device is discovered to be presently unpaired with respect to the remote media playback system when the pairing data store indicates that the discovered portable device has not logged into the media playback application.

17. The method of claim 6, wherein communicating the prompt comprises communicating a clickable link for display via a graphical user interface of the presently unpaired portable device, such that activating the clickable link initiates a pairing routine to pair the presently unpaired portable device with the remote media playback system.

18. A non-transitory processor-readable medium comprising processor-readable instructions that cause one or more processors of a television receiver to:
execute a network discovery routine to discover whether a portable device is communicatively coupled with the LAN;
query a pairing data store, in response to the network discovery routine discovering that the portable device is communicatively coupled with the local-area network, to determine whether the discovered portable device is a presently unpaired portable device with respect to a remote media playback system associated with the television receiver; and
communicate a prompt to the presently unpaired portable device, automatically in response to the query determining that the discovered portable device is a presently unpaired portable device, the prompt directing the presently unpaired portable device to pair with the remote media playback system.

19. The non-transitory processor-readable medium of claim 18, wherein the processor-readable instructions cause the one or more processors of the television receiver further to:
receive a pairing indication in response to the presently unpaired portable device completing a pairing interaction with the remote media playback system; and
update the pairing data store to indicate the presently unpaired portable device as a paired portable device.

20. The non-transitory processor-readable medium of claim 18, wherein the processor-readable instructions cause the one or more processors of the television receiver further to:
detect that the discovered portable device is a subscriber portable media playback device,
wherein the one or more processors query in response to the detecting.
